(19) United States
(12) Patent Application Publication
(10) Pub. No.: US 2026/0348889 A1
(43) Pub. Date: Nov. 5, 2026

(54) METHOD AND APPARATUS

(71) Applicant: THE UNIVERSITY OF LIVERPOOL, Liverpool (GB)

(72) Inventors: Jack TAYLOR, Liverpool (GB); Nigel BROWNING, Liverpool (GB); Jack WELLS, Liverpool (GB); Daniel NICHOLLS, Liverpool (GB); Alex ROBINSON, Liverpool (GB)

(21) Appl. No.: 19/099,270

(22) PCT Filed: Jul. 31, 2023
(86) PCT No.: PCT/GB2023/052018

§ 371 Date: Jan. 28, 2025

(30) Foreign Application Priority Data
Jul. 29, 2022 (GB) 2211085.2

(51) Int. Cl. G01N 23/2251

(52) U.S. Cl. CPC G01N 23/2251; G01N 2223/401

(57) ABSTRACT

A method of reconstructing electron microscopy images of size [M×N] pixels of a first sample, the method implemented by a computer comprising a processor and a memory, the method comprising:
obtaining, using a first detector, a first electron microscopy image of the first sample;
learning a set of dictionaries, including a first dictionary including a set of p₁ atoms, using the obtained first electron microscopy image of the first sample;
acquiring, using a second detector, a second sparse set of S sub-images, including a first sub-image of size [a×b] pixels wherein a,b∈[2, min{M,N}], of the first sample; and
reconstructing a second electron microscopy image of size [M×N] pixels of the first sample using the acquired second sparse set of S sub-images of the first sample and the learned set of dictionaries.

### FIELD

The present invention relates to reconstruction of images, for example electron microscopy images.

### BACKGROUND TO THE INVENTION

Over the last few decades, major developments in scanning transmission electron microscopy (STEM) such as modern aberration-correctors have enabled material scientists to analyse and characterise materials at the highest possible spatial resolution, allowing for atomic-scale observations of a materials structure, composition, and chemical properties. However, this unprecedented increase in achievable resolution has come at the cost of an increased operational probe current, now typically several orders of magnitude above that which many materials can withstand without significant damage to the sample. The effect of this is the shifting of the limiting factor from the physical properties of the instrument to that of the sample itself; in particular, the sensitivity of the sample to electron beam damage. In recent years, compressive sensing (CS) has been successfully applied to the field of low-dose STEM, where a deliberately subsampled (incomplete) scan is performed, acquiring an image with fewer pixels than in a regular raster scan, and reconstructing a fully sampled image from the reduced measurements. CS-STEM has been shown to reduce the dose, dose rate, and dose overlap necessary to recover a fully sampled image, all of which directly contribute to electron beam-damage, allowing (for example) high-angle annular dark field (HAADF) images of calcium carbonate (CaCO₃) to be acquired without significant amorphization of the sample.

By manipulating the scanning coils in such a way as to perform an incomplete scan, i.e. taking measurements at only a subset of the pixels (e.g. 25%), not only does the sample receive a lower electron-dose per frame (and thus enable more sensitive materials to be imaged), the framerate (or inversely, acquisition time) is also improved. This may be particularly beneficial for those taking many independent images to form a 3D data cube, such as in cryo-FIB tomography, as well as those interested in imaging time-dependent phenomena. Furthermore, the reduced acquisition time may have the additional benefit of reducing time-related instabilities in the microscope, such as sample drift, potentially improving the image quality of a regular scan.

Once a subsampled scan has been taken, it must then be passed to a reconstruction (image inpainting) process, usually solving a system of underdetermined linear equations, where most of the time penalty is incurred. This process will often take the form of a combination of a dictionary learning algorithm, and a sparse coding step algorithm, and a reconstruction step, though there has been significant work in developing machine learning alternatives. Traditional image inpainting methods rely on a dictionary learning algorithm such as the Method of Optimal Directions (MOD) or K-SVD, an algorithm which forms a dictionary of representative signal patterns from a fully sampled image, which (via a sparse linear combination with corresponding scalar coefficients) can closely represent any given patch of the image. This dictionary, along with a now (often artificially) subsampled version of the same image may then be passed to a sparse pursuit algorithm to solve the following system of equations (for each overlapping patch of the image):

vᵢ=Φᵢ·(Dαᵢ+ϵᵢ) (Equation 1)

[symbol]

=Dαᵢ (Equation 2)

where vᵢ∈ [symbol] ⁿ is the measured (subsampled) signal subject to noise ϵ∈ [symbol] ⁿ, Φᵢ is the binary sensing matrix (or ‘mask’, determining the locations of missing pixels), [symbol] ∈ [symbol] ⁿ is the reconstructed (fully-sampled) signal represented using the given dictionary D∈ [symbol] ^{n×k} and corresponding ‘weight’ vector α∈ [symbol] ^{k}. Examples of algorithms capable of solving this includes Orthogonal Matching Pursuit (OMP) and its many similar variants which minimise the l₀ norm of the solution to induce sparsity or Basis Pursuit which minimises the l₁ norm. More recently, a reformulation of the dictionary learning problem into the Bayesian regime has produced algorithms, such as Beta-Process Factor Analysis (BPFA) which are capable of so-called ‘blind inpainting’, i.e. the formation of a dictionary, and subsequent reconstruction of an image using only the subsampled image as its input (therefore, there is no need for a mask to be provided a priori or a fully-sampled version of the image to be acquired at any stage in the process).

Any of these methods, assuming appropriate parameters, is capable of producing a high-quality reconstruction of the fully sampled image from the subsampled (also known as sparse) image (i.e. the corresponding subsampled image) and has been successfully applied to the field of STEM.

However, reconstruction of some fully sampled images, for example multi-band or hyperspectral images (such as characteristic or Bremsstrahlung X-ray images, energy dispersive spectroscopy, EDS, images, energy dispersive X-ray spectroscopy, EDX, images, secondary electron images, and/or electron energy loss spectroscopy, EELS, images), from the subsampled image may be problematic. For example, multi-band or hyperspectral images typically require relatively long dwell times to provide relatively high-quality multi-band or hyperspectral images for dictionary learning, which is unsuitable for imaging beam-sensitive materials. For example, reconstruction of subsampled multi-band or hyperspectral images using dictionaries learned using relatively low-quality multi-band or hyperspectral images results in poor reconstruction.

Hence, there is a need to improve analytical characterisation, for example by electron microscopy.

### SUMMARY OF THE INVENTION

It is one aim of the present invention, amongst others, to provide a method of reconstructing electron microscopy images which at least partially obviates or mitigates at least some of the disadvantages of the prior art, whether identified herein or elsewhere. For instance, it is an aim of embodiments of the invention to provide a method of reconstructing electron microscopy images that improves a quality, resolution, sensitivity and/or signal to noise ratio of image, for example a subsampled multi-band or hyperspectral image.

A first aspect provides a method of reconstructing electron microscopy images of size [M×N] pixels of a first sample, the method implemented by a computer comprising a processor and a memory, the method comprising:
obtaining, using a first detector, a first set of electron microscopy images, including a first electron microscopy image, of the first sample;
dictionary learning a set of dictionaries, including a first dictionary including a set of p₁ atoms, using the obtained first set of electron microscopy images of the first sample;
acquiring, using a second detector, a second sparse set of S sub-images, including a first sub-image of size [a×b] pixels wherein a,b∈[2, min{M,N}], of the first sample; and
reconstructing a second set of electron microscopy images, including a first electron microscopy image of size [M×N] pixels, of the first sample using the acquired second sparse set of S sub-images of the first sample and the learned set of dictionaries.

A second aspect provides a method of controlling an electron microscope, the method implemented, at least in part, by a computer comprising a processor and a memory, the method comprising:
obtaining parameters of the electron microscopy;
acquiring, using a first detector, a first set of electron microscopy images, including a first electron microscopy image, of the first sample comprising controlling the electron microscope using the obtained parameters of the electron microscopy;
acquiring, using a second detector, a second sparse set of S sub-images, including a first sub-image of size [a×b] pixels wherein a,b∈[2,min{M,N}], of the first sample comprising controlling the electron microscope using the obtained parameters of the electron microscopy;
reconstructing a second set of electron microscopy images, including a first electron microscopy image of size [M×N] pixels, of the first sample according to any of claims 1 to 10 using the acquired second sparse set of S sub-images;
comparing the first electron microscopy image, included in the second set of electron microscopy images, against thresholds of one or more target properties of the first electron microscopy image, included in the second set of electron microscopy images;
adapting the parameters of the electron microscopy based on a result of the comparing; and acquiring an adapted second sparse set of S acquired sub-images, including a first sub-image of size [a×b] pixels wherein a,b∈[2, min{M,N}], of the first sample comprising controlling the electron microscope using the adapted parameters of the electron microscopy.

A third aspect provides a computer comprising a processor and a memory configured to implement a method according to any of the first aspect and/or the second aspect, a computer program comprising instructions which, when executed by a computer comprising a processor and a memory, cause the computer to perform a method according to any of the first aspect and/or the second aspect or a non-transient computer-readable storage medium comprising instructions which, when executed by a computer comprising a processor and a memory, cause the computer to perform a method according to any of the first aspect and/or the second aspect.

A fourth aspect provides an electron microscope including a computer comprising a processor and a memory configured to implement a method according to any of the first aspect and/or the second aspect.

A fifth aspect provides use of a dictionary, learned using a first electron microscopy image, obtained using a first detector, of a sample, in reconstructing a second electron microscopy image, acquired using a second detector, of the sample.

### DETAILED DESCRIPTION OF THE INVENTION

According to the present invention there is provided a method of reconstructing an electron microscopy image, as set forth in the appended claims. Also provided is a method of controlling an electron microscope, a computer, a computer program, a non-transient computer-readable storage medium, an electron microscope and use of a pre-learned dictionary. Other features of the invention will be apparent from the dependent claims, and the description that follows.

### Reconstructing Electron Microscopy Images

The first aspect provides a method of reconstructing electron microscopy images of size [M×N] pixels of a first sample, the method implemented by a computer comprising a processor and a memory, the method comprising:
obtaining, using a first detector, a first set of electron microscopy images, including a first electron microscopy image, of the first sample;
dictionary learning a set of dictionaries, including a first dictionary including a set of p₁ atoms, using the obtained first set of electron microscopy images of the first sample;
acquiring, using a second detector, a second sparse set of S sub-images, including a first sub-image of size [a×b] pixels wherein a,b∈[2, min{M,N}], of the first sample; and
reconstructing a second set of electron microscopy images, including a first electron microscopy image of size [M×N] pixels, of the first sample using the acquired second sparse set of S sub-images of the first sample and the learned set of dictionaries.

In this way, the second set of electron microscopy images, including the first electron microscopy image of size [M×N] pixels, of the first sample is reconstructed using the acquired second sparse set of S sub-images of the first sample and the learned set of dictionaries, wherein the learned set of dictionaries, including the first dictionary including a set of p₁ atoms, is learned using the first set of electron microscopy images, including the first electron microscopy image, of the first sample, obtained using the first detector.

For example, a dictionary (i.e. the first dictionary including a set of p₁ atoms included in the set of dictionaries) may be learned using a fully-sampled, acquired, backscattered electron (BSE) image (i.e. the first electron microscopy image included in the first set of electron microscopy images obtained using the first detector) of a particular sample (i.e. the first sample) and a sub-sampled, acquired, energy dispersive spectroscopy (EDS) image (i.e. second sparse set of S sub-images, including a first sub-image of size [a×b] pixels wherein a,b∈[2,min{M,N}] acquired using the second detector) of the particular sample may be reconstructed using the learned dictionary. In this way, reconstruction of the EDS image is improved compared with reconstructing the EDS image using a dictionary trained using a fully-sampled, acquired EDS image of the particular sample since the quality, resolution, sensitivity and/or signal to noise ratio of the BSE image is relatively higher compared with the EDS image.

The inventors have developed a novel method according to the first aspect for reconstructing high-quality, multi-band electron microscopy images from a target signal source (i.e. from the second detector), by building a sparse representation of auxiliary signals from a related secondary signal source (i.e. from the first detector). This method according to the first aspect has many applications in electron microscopy, as many signal types can be acquired from a single sample, either simultaneously or sequentially, from sensors of varying resolutions, contrasts, specificities, and noise levels. This method according to the first aspect builds a sparse representation of signals from sensors with finer spatial features in the image content (i.e. the first detector e.g. more sensitive instruments), to improve the overall reconstruction quality of a target signal of the same sample source, which may have been acquired through worse quality sensors (i.e. the second detector), or the acquisition is restricted in quality due to various system constraints (such as dwell time) or the underlying physics of the signal being acquired (i.e. smaller scattering cross section).

This method according to the first aspect has many potential benefits in the field of electron microscopy including:
i. Improving the reconstruction quality of subsampled or poorly acquired images by constructing the sparse representation from a signal of a higher quality source.
ii. Improving the reconstruction quality of multi-band, or hyperspectral images (such as Energy-dispersive X-ray spectroscopy maps in electron microscopy) by constructing the sparse representation from images formed from more sensitive instruments such as backscattered electron images in scanning electron microscopy or contrast images formed in dark/bright-field annular detectors.
iii. Improving the reconstruction quality of images from signal sources that are challenging to sample from, by constructing a sparse representation of signals from a secondary source which is more efficient to sample image content from. For example, X-ray maps require a long dwell time to form a high-quality image, which is unsuitable for imaging beam-sensitive materials. Constructing the sparse representation from a signal source which does not have such restrictions can improve the quality of the reconstructed images of the target signal.
iv. Improving the reconstruction speeds for multi-band images in trainable settings such as dictionary learning or deep learning by only requiring a single image to build a dictionary, which is then used to reconstruct all bands of that image instead of constructing multiple representations to reconstruct the full bands of the image
v. Improving reconstructions for any imaging system which acquires multiple signal types, including parallel acquisition and sequential (probe) acquisition systems.

In other words, the method according to the first aspect allows for the efficient reconstruction of high-quality, multi-band images for many electron microscopy applications, improving the time-to-solution for acquiring images from multiple signal sources and particularly important in imaging beam sensitive materials by improving the efficiency of acquisition of hyperspectral images.

In more detail, the method according to the first aspect improves reconstruction quality of signals acquired with relatively poor signal to noise in electron microscopy, for example, by learning sparse representations from a higher quality signal source. In this way, a contrast image representation may be used to reconstruct EDS maps and/or HAADF images may be used to reconstruct BF and/or DF images. Further, any setting which makes use of multiple signal sources (airborne—IR, visible etc) may be improved. For example, EDS maps often have system constraints such as relatively long scan times (dwell times) to construct high-quality signals, which is challenging for many samples, applications, instrumentation and/or environments.

This method according to the first aspect makes it possible to reconstruct a high quality reference of these heavily noisy images (e.g. EDS maps) and overcome system constraints by leveraging the available high quality information. This method according to the first aspect may be applied in simultaneous acquisition systems (when multiple signals are being acquired) or when a reference is available beforehand (i.e. successively). This method according to the first aspect greatly improves reconstruction time for large multi-band images as only a single high-quality representation is constructed, for example which may be solely built from the higher quality signal source or a mixture with matrix decomposition approaches

### Reconstructing Electron Microscopy Images

While the method according to the first aspect relates to reconstructing electron microscopy images of samples, more generally, the method may be applied to reconstructing images of samples acquired using other analytical techniques. Hence, more generally, the first aspect provides a method of reconstructing images of size [M×N] pixels of a first sample due to interaction of electromagnetic radiation and/or particles with the first sample. It should be understood that the steps of the method according to the first aspect are implemented mutatis mutandis. In other words, while the method according to the first aspect relates to reconstructing electron microscopy images of samples, the method may be applied mutatis mutandis to other image reconstruction methods, for example for optical and X-ray techniques as well as reconstructions for basic physical properties such as band structure. Hence, more generally, the first aspect provides a method of reconstructing physical properties of a chemical, material and/or biological system and images produced of those systems by interaction with light, X-rays, protons, neutrons and/or electrons or by any other means.

The first aspect provides the method of reconstructing electron microscopy images of size [M×N] pixels of the first sample. It should be understood that the electron microscopy image is reconstructed (i.e. synthesised, generated, calculated) using the computer (i.e. in silico) rather than completely acquired, for example using an electron microscope. It should be understood that the electron microscopy image is of the first sample and hence the first image is due to the interaction of electrons with the first sample, as defined by the obtained parameters of the electron microscopy and/or attributes of the sample. Electron microscopy is known. Electron microscopy images are known, for example transmission electron microscopy images, scanning electron microscopy images and electron diffraction patterns. Typically, electron microscopy images are stored in raw data formats (binary, bitmap, TIFF, MRC, etc.), other image data formats (PNG, JPEG) or in vendor-specific proprietary formats (dm3, emispec, etc.). The electron microscopy images may be compressed (preferably, lossless compression though lossy compression there used to reduce file size by 5% to 10% while providing sub-2 Å reconstruction) or uncompressed.

TIFF and MRC file formats may be used for high quality storage of image data. Similar to MRCs, TIFFs tend to be large in file size with 32-bit MRC and 32-bit TIFF image having similar or identical file sizes. For TIFFs, the disk space may be reduced using native compression. The most common TIFF compressions are the Lempel-Ziv-Welch algorithm, or LZW, and ZIP compression. These strategies use codecs, or table-based lookup algorithms, that aim to reduce the size of the original image. Both LZW and ZIP are lossless compression methods and so will not degrade image quality. Two commonly used photography file formats that support up to 24-bit colour are PNG (Portable Network Graphics) and JPEG (Joint Photographic Experts Group). Electron micrographs typically are in grayscale so may be better suited to 8-bit file formats, which are also used in print media. PNG is a lossless file format and can utilize LZW compression similar to TIFF images. JPEG is a lossy file format that uses discrete cosine transform (DCT) to express a finite sequence of data points in terms of a sum of cosine functions. JPEG format may be avoided for archiving since quality may be lost upon each compression during processing. JPEG has a range of compression ratios ranging from JPEG100 with the least amount of information loss (corresponding to 60% of the original file size for the frame stack and 27% for the aligned sum image) to JPEG000 with the most amount of information loss (corresponding to 0.4% of the original file size for the frame stack and 0.4% for the aligned sum image).

In one example, the electron microscopy image is of size [M×N] pixels, wherein 240≤M,N≤10,000,000, preferably 1,000≤M,N≤5,000,000, more preferably 2,000≤M,N≤4,000,000.

TABLE 1
Example electron microscopy image of size [M × N] pixels.

| M | N |
|---|---|
| 320 | 240 |
| 640 | 480 |
| 1024 | 768 |
| 1280 | 1024 |
| 720 | 756 |
| 1280 | 720 |
| 1920 | 1080 |
| 4096 | 2160 |
| 3996 | 2160 |
| 4096 | 1716 |
| 3840 | 2160 |
| 7680 | 4320 |
| 3840 | 1644 |
| 3838 | 3710 |
| 7676 | 7420 |

For example, high resolution electron images may have sizes from [512×512] pixels to [10,000,000×10,000,000], depending on the stability of the electron microscope.

In one example, the electron microscopy image is grayscale, for example 8-bit, 16-bit, 24-bit or 32-bit, preferably 8-bit.

The method is implemented by the computer comprising the processor and the memory. Generally, the method may be performed using a single processor, such as an Intel® Core i3-3227U CPU @1.90 GHz or better, or multiple processors and/or GPUs. Suitable computers are known.

### Obtaining, Using a First Detector, a First Set of Electron Microscopy Images

The method comprises obtaining, using the first detector, the first set of electron microscopy images, including the first electron microscopy image, of the first sample.

In one example, the first detector is selected from a group consisting of: a backscattered electron detector; a visible light detector; an Auger electron detector; a characteristic or Bremsstrahlung X-ray detector; an energy dispersive spectroscopy, EDS, detector; an energy dispersive X-ray spectroscopy, EDX, detector; a secondary electron detector; an electron energy loss spectroscopy, EELS, detector; and a contrast detector for example a dark field detector such as a high-angle annular dark-field detector or an annular dark field detector; a bright field detector such as an annular bright field detector; or a Z contrast detector; preferably wherein the first electron microscopy detector of the first sample is selected from a group consisting of: a backscattered electron detector; and a contrast detector for example a dark field detector such as a high-angle annular dark-field detector or an annular dark field detector; a bright field detector such as an annular bright field detector; or a Z contrast detector. Suitable detectors are known.

It should be understood that the first detector and the second detector are mutually different.

In this way, the first detector has a relatively higher quality, resolution, sensitivity and/or signal to noise ratio, for example compared with the second detector, for example for a given acquisition time.

In one example, a sensitivity of the first detector is greater than a sensitivity of the second detector, for example wherein sensitivity is signal to noise ratio for a particular image or map

In one example, obtaining, using the first detector, the first set of electron microscopy images, including the first electron microscopy image, of the first sample comprises and/or is acquiring, using the first detector, the first electron microscopy image, included in the first set of electron microscopy images, of the first sample.

In this way, the first electron microscopy image, included in the first set of electron microscopy images, is acquired (i.e. measured c.f. simulated) using the first detector (i.e. at least the first electron microscopy image included in the first set of electron microscopy images is acquired using the first detector).

In one example, obtaining, using the first detector, the first set of electron microscopy images, including the first electron microscopy image, of the first sample comprises and/or is acquiring, using the first detector, the first set of electron microscopy images, including the first electron microscopy image, of the first sample.

In this way, the first set of electron microscopy images, including the first electron microscopy image, is acquired (i.e. measured c.f. simulated) using the first detector (i.e. all the electron microscopy images included in the first set of electron microscopy images are acquired using the first detector).

In one example, acquiring, using the first detector, the first set of electron microscopy images, including the first electron microscopy image, of the first sample comprises:
acquiring, using the first detector, a first sparse set of S sub-images, including a first sub-image of size [a×b] pixels wherein a,b∈[2,min{M,N}], of the first sample; and
reconstructing the first electron microscopy image, included in the first set of electron microscopy images, of the first sample using the acquired first sparse set of S sub-images of the first sample.

In this way, the first electron microscopy image is sub-sampled and reconstructed, for example using a learned dictionary, learned using a fully sampled image of the first sample or another sample, for example of the same material or sample type. In one example, all the electron microscopy images included in the first set of electron microscopy images are sub-sampled mutatis mutandis.

In one example, acquiring, using the first detector, the first set of electron microscopy images, including the first electron microscopy image comprises fully acquiring, using the first detector, the first electron microscopy image, included in the first set of electron microscopy images, wherein the first electron microscopy image, included in the first set of electron microscopy images, of the first sample comprises and/or is a fully sampled acquired electron microscopy image of the first sample.

In this way, the first electron microscopy image is fully sampled (i.e. 100%, without reconstructing). Full sampled images for the first set of electron microscopy images are preferred. In one example, all the electron microscopy images included in the first set of electron microscopy images are fully sampled mutatis mutandis.

In one example, obtaining, using the first detector, the first set of electron microscopy images, including the first electron microscopy image, of the first sample comprises and/or is obtaining, using the first detector, the first set of electron microscopy images, including the first electron microscopy image, of the first sample, wherein the first electron microscopy image, included in the first set of electron microscopy images, of the first sample is selected from a group consisting of: a backscattered electron image; a visible light image; an Auger electron image; a characteristic or Bremsstrahlung X-ray image; an energy dispersive spectroscopy, EDS, image; an energy dispersive X-ray spectroscopy, EDX, image; a secondary electron image; an electron energy loss spectroscopy, EELS, image; and a contrast image for example a dark field image such as a high-angle annular dark-field image or an annular dark field image; a bright field image such as an annular bright field image; or a Z contrast image; preferably wherein the first electron microscopy image of the first sample is selected from a group consisting of: a backscattered electron image; and a contrast image for example a dark field image such as a high-angle annular dark-field image or an annular dark field image; a bright field image such as an annular bright field image; or a Z contrast image.

In this way, the first electron microscopy image, included in the first set of electron microscopy images, has a relatively high quality, resolution, sensitivity and/or signal to noise ratio, for example compared with the first electron microscopy image, included in the second set of electron microscopy images. In one example, all the electron microscopy images included in the first set of electron microscopy images are selected from the same lists mutatis mutandis.

In one example, obtaining, using the first detector, the first set of electron microscopy images, including the first electron microscopy image, of the first sample comprises and/or is simulating, using the first detector, the first set of electron microscopy images, including the first electron microscopy image, of the first sample.

In this way, the first set of electron microscopy images, including the first electron microscopy image, of the first sample is simulated (i.e. calculated in silico).

In one example, obtaining, using the first detector, the first electron microscopy image, included in the first set of electron microscopy images, of the first sample comprises and/or is simulating, using the first detector, the first set of electron microscopy images, including the first electron microscopy image, of the first sample.

In this way, the first electron microscopy image, included in the first set of electron microscopy images, of the first sample is simulated (i.e. calculated in silico).

### Dictionary Learning

The method comprises dictionary learning the set of dictionaries, including the first dictionary including a set of p₁ atoms, using the obtained first set of electron microscopy images of the first sample. It should be understood that sparse coding is a representation learning method which aims at finding a sparse representation of the input data (also known as sparse coding) in the form of a linear combination of basic elements as well as those basic elements themselves. These elements are called atoms and they compose a dictionary. Atoms in the dictionary are not required to be orthogonal, and they may be an over-complete spanning set. This problem setup also allows the dimensionality of the signals being represented to be higher than the one of the signals being observed. These two properties lead to having seemingly redundant atoms that allow multiple representations of the same signal but also provide an improvement in sparsity and flexibility of the representation. In one example, the set of p₁ atoms includes pt atoms, wherein p₁ is in a range from 4 to 4096, preferably in a range from 16 to 2048, more preferably in a range from 64 to 1024, for example 128, 256 or 512.

### Acquiring Sparse Set of S Acquired Sub-Images

The method comprises acquiring, using the second detector, the second sparse set of S sub-images, including the first sub-image of size [a×b] pixels wherein a,b∈[2,min{M,N}], of the first sample.

It should be understood that the first detector and the second detector are mutually different.

It should be understood that the second sparse set of S sub-images, including the first sub-image of size [a×b] pixels wherein a,b∈[2, min{M,N}], of the first sample, is acquired (i.e. measured c.f. simulated) using the second detector.

It should be understood that the second sparse set of S sub-images, including the first sub-image of size [a×b] pixels wherein a,b∈[2, min{M,N}], of the first sample comprises and/or is a sub-sampled image of the first sample.

In one example, acquiring, using the second detector, the second sparse set of S sub-images, including the first sub-image of size [a×b] pixels wherein a,b∈[2,min{M,N}], of the first sample comprises acquiring, using the second detector, the second sparse set of S sub-images, including the first sub-image of size [a×b] pixels wherein a,b∈[2,min{M,N}], of the first sample, wherein a sub-sampling is in a range from 0.1% to 25%, preferably in a range from 0.25% to 15%, more preferably in a range from 0.5% to 7.5%, most preferably in a range from 1% to 3.75%, for example 1.562%, 3.125%, 6.25%, 12.5% or 25%, by area of the first electron microscopy image of size [M×N] pixels, included in the second set of electron microscopy images, of the first sample.

In one example, the second detector is selected from a group consisting of: a backscattered electron detector; a visible light detector; a Auger electron detector; a characteristic or Bremsstrahlung X-ray detector; an energy dispersive spectroscopy, EDS, detector; an energy dispersive X-ray spectroscopy, EDX, detector; a secondary electron detector; an electron energy loss spectroscopy, EELS, detector; and a contrast detector for example a dark field detector such as a high-angle annular dark-field detector or an annular dark field detector; a bright field detector such as an annular bright field detector; or a Z contrast detector; preferably wherein the second electron microscopy detector of size [M×N] pixels of the first sample is selected from a group consisting of: a characteristic or Bremsstrahlung X-ray detector; an energy dispersive spectroscopy, EDS, detector; an energy dispersive X-ray spectroscopy, EDX, detector; a secondary electron detector; an electron energy loss spectroscopy, EELS, detector; and a contrast detector for example a dark field detector such as a high-angle annular dark-field detector or an annular dark field detector. Suitable detectors are known.

In this way, the second detector has a relatively lower quality, resolution, sensitivity and/or signal to noise ratio, for example compared with the first detector, for example for a given acquisition time.

In one example, acquiring, using the second detector, the second sparse set of S sub-images, including the first sub-image of size [a×b] pixels wherein a,b∈[2,min{M,N}], of the first sample comprises and/or is acquiring, using the second detector, the second sparse set of S sub-images, including the first sub-image of size [a×b] pixels wherein a,b∈[2, min{M,N}], of the first sample, wherein the second sparse set of S sub-images, including the first sub-image of size [a×b] pixels wherein a,b∈[2, min{M,N}], of the first sample is selected from a group consisting of: a sparse backscattered electron image; a sparse visible light image; a sparse Auger electron image; a sparse characteristic or Bremsstrahlung X-ray image; a sparse energy dispersive spectroscopy, EDS, image; a sparse energy dispersive X-ray spectroscopy, EDX, image; a sparse secondary electron image; a sparse electron energy loss spectroscopy, EELS, image; and a sparse contrast image for example a sparse dark field image such as a sparse high-angle annular dark-field image or a sparse annular dark field image; a sparse bright field image such as a sparse annular bright field image; or a sparse Z contrast image; preferably wherein the second sparse set of S sub-images, including the first sub-image of size [a×b] pixels wherein a,b∈[2,min{M,N}], of the first sample is selected from a group consisting of: a sparse characteristic or Bremsstrahlung X-ray image; a sparse energy dispersive spectroscopy, EDS, image; a sparse energy dispersive X-ray spectroscopy, EDX, image; a sparse secondary electron image; a sparse electron energy loss spectroscopy, EELS, image; and a sparse contrast image for example a sparse dark field image such as a sparse high-angle annular dark-field image or a sparse annular dark field image.

It should be understood that the second sparse set of S sub-images, including the first sub-image of size [a×b] pixels, is a sparse (also known as subsampled) set, wherein the total area (and/or number of pixels) of the set of S sub-images, including the first sub-image of size [a×b] pixels, is less than the area (and/or number of pixels) of the first electron microscopy image, included in the second set of electron microscopy images, of size [M×N] pixels. In one example, the total area (and/or number of pixels) of the set of S sub-images, including the first sub-image of size [a×b] pixels, is in a range from 0.1% to 90%, preferable in a range from 1% to 75%, more preferably in a range from 10% to 50%, most preferably in a range from 15% to 35% of the area (and/or number of pixels) of the first electron microscopy image, included in the second set of electron microscopy images, of size [M×N] pixels.

It should be understood that S is a natural number. In one example, the second sparse set of S sub-images includes S sub-images, wherein S≥1, preferably wherein 1≤S≤10.000, more preferably wherein 10≤S≤5,000, most preferably wherein 100≤S≤1,000. In one example, each sub-image of the set of S sub-images has a size [a×b] pixels. Preferably, the sub-images are the same size to maximise dispersion of sampling. In one example, each sub-image of the set of S sub-images has a different size. In one example, the sub-images do not mutually overlap. In one example, at least some of the sub-images mutually overlap. Preferably, the sub-images do not mutually overlap since mutual overlapping decreases the efficiency and sparsity. In one example, the sub-images are not mutually adjacent. In one example, at least some of the sub-images are mutually adjacent. Preferably, the sub-images are not mutually adjacent since mutual adjacency decreases the efficiency and sparsity.

It should be understood that a,b are natural numbers. In one example, a=b. In one example, a≠b. In one example, 2≤a,b≤10, preferably 2≤a,b≤5, more preferably 2≤a,b≤3. In one preferred example, a=b=2.

### First Detector and Second Detector

In one example, the first detector and the second detector are selected from a combination according to Table 1.

TABLE 1
Combinations of first detector and second detector. Preferred combinations in bold.

| | | Second detector | | | | | | | |
|---|---|---|---|---|---|---|---|---|---|
| | | | | | characteristic | | | | |
| | | | visible | Auger | or | | | secondary | |
| | | BSE | light | electron | Bremsstrahlung | EDS | EDX | electron | EELS |
| | | detector | detector | detector | X-ray | detector | detector | detector | detector |
| First | BSE detector | | ✓ | ✓ | ✓ | ✓ | ✓ | ✓ | ✓ |
| detector | visible light | ✓ | | ✓ | ✓ | ✓ | ✓ | ✓ | ✓ |
| | detector | | | | | | | | |
| | Auger electron | ✓ | ✓ | | ✓ | ✓ | ✓ | ✓ | ✓ |
| | detector | | | | | | | | |
| | characteristic | ✓ | ✓ | ✓ | | ✓ | ✓ | ✓ | ✓ |
| | or | | | | | | | | |
| | Bremsstrahlung | | | | | | | | |
| | X-ray detector | | | | | | | | |
| | EDS detector | ✓ | ✓ | ✓ | ✓ | | ✓ | ✓ | ✓ |
| | EDX detector | ✓ | ✓ | ✓ | ✓ | ✓ | | ✓ | ✓ |
| | secondary | ✓ | ✓ | ✓ | ✓ | ✓ | ✓ | | ✓ |
| | electron | | | | | | | | |
| | detector | | | | | | | | |
| | EELS detector | ✓ | ✓ | ✓ | ✓ | ✓ | ✓ | ✓ | |
| | contrast | ✓ | ✓ | ✓ | ✓ | ✓ | ✓ | ✓ | ✓ |
| | detector | | | | | | | | |
| | DF detector | ✓ | ✓ | ✓ | ✓ | ✓ | ✓ | ✓ | ✓ |
| | HAADF | ✓ | ✓ | ✓ | ✓ | ✓ | ✓ | ✓ | ✓ |
| | detector | | | | | | | | |
| | ADF detector | ✓ | ✓ | ✓ | ✓ | ✓ | ✓ | ✓ | ✓ |
| | BF detector | ✓ | ✓ | ✓ | ✓ | ✓ | ✓ | ✓ | ✓ |
| | ABF detector | ✓ | ✓ | ✓ | ✓ | ✓ | ✓ | ✓ | ✓ |
| | Z contrast | ✓ | ✓ | ✓ | ✓ | ✓ | ✓ | ✓ | ✓ |
| | detector | | | | | | | | |

| | | Second detector | | | | | | |
|---|---|---|---|---|---|---|---|---|
| | | | | | | | | Z |
| | | contrast | DF | HAADF | ADF | BF | ABF | contrast |
| | | detector | detector | detector | detector | detector | detector | detector |
| First | BSE detector | ✓ | ✓ | ✓ | ✓ | ✓ | ✓ | ✓ |
| detector | visible light | ✓ | ✓ | ✓ | ✓ | ✓ | ✓ | ✓ |
| | detector | | | | | | | |
| | Auger electron | ✓ | ✓ | ✓ | ✓ | ✓ | ✓ | ✓ |
| | detector | | | | | | | |
| | characteristic | ✓ | ✓ | ✓ | ✓ | ✓ | ✓ | ✓ |
| | or | | | | | | | |
| | Bremsstrahlung | | | | | | | |
| | X-ray detector | | | | | | | |
| | EDS detector | ✓ | ✓ | ✓ | ✓ | ✓ | ✓ | ✓ |
| | EDX detector | ✓ | ✓ | ✓ | ✓ | ✓ | ✓ | ✓ |
| | secondary | ✓ | ✓ | ✓ | ✓ | ✓ | ✓ | ✓ |
| | electron | | | | | | | |
| | detector | | | | | | | |
| | EELS detector | ✓ | ✓ | ✓ | ✓ | ✓ | ✓ | ✓ |
| | contrast | | ✓ | ✓ | ✓ | ✓ | ✓ | ✓ |
| | detector | | | | | | | |
| | DF detector | ✓ | | ✓ | ✓ | ✓ | ✓ | ✓ |
| | HAADF | ✓ | ✓ | | ✓ | ✓ | ✓ | ✓ |
| | detector | | | | | | | |
| | ADF detector | ✓ | ✓ | ✓ | | ✓ | ✓ | ✓ |
| | BF detector | ✓ | ✓ | ✓ | ✓ | | ✓ | ✓ |
| | ABF detector | ✓ | ✓ | ✓ | ✓ | ✓ | | ✓ |
| | Z contrast | ✓ | ✓ | ✓ | ✓ | ✓ | ✓ | |
| | detector | | | | | | | |

For example, detector combinations include (first detector i.e. higher signal/second detector i.e. lower signal):
i. Back scattered electron/energy dispersive x-ray spectroscopy map (EDS) for SEM, STEM
ii. Back scattered electron (electron beam)/secondary electron (ion beam) for FIB-SEM
iii. Bright field/(high angle) annular dark field for STEM
iv. Bright field or dark field/electron energy loss spectroscopy map (EELS) for STEM

Speaking more generally, any form of imaging in which two or more signals are acquired with one of the signals being weaker than the other can benefit from this, so the scope is very broad. This could even be done with one detector in which a high signal image is acquired followed by a low signal image. For electron microscopy, this can also be extended to include ptychography/4D-STEM which offers a number of additional signal types to be acquired (Centre of mass, phase imaging, differential phase contrast).

Generally, any form of imaging in which two or more signals are acquired with one of the signals being weaker than the other can benefit from this. This could even be done with one detector in which a high signal image is acquired followed by a low signal image. For electron microscopy, this can also be extended to include ptychography/4D-STEM which offers a number of additional signal types to be acquired (centre of mass, phase imaging, differential phase contrast).

In one example, the first set of electron microscopy images, including the first electron microscopy image, of the first sample and the second sparse set of S sub-images, including the first sub-image of size [a×b] pixels wherein a,b∈[2,min{M,N}], of the first sample are selected from a combination according to Table 1 mutatis mutandis.

Simultaneously and/or Successively

In one example, obtaining, using the first detector, the first set of electron microscopy images, including the first electron microscopy image, of the first sample; and acquiring, using the second detector, the second sparse set of S sub-images, including the first sub-image of size [a×b] pixels wherein a,b∈[2,min{M,N}], of the first sample; comprises simultaneously obtaining, using the first detector, the first set of electron microscopy images, including the first electron microscopy image, of the first sample; and acquiring, using the second detector, the second sparse set of S sub-images, including the first sub-image of size [a×b] pixels wherein a,b∈[2,min{M,N}], of the first sample.

In this way, the first set of electron microscopy images, including the first electron microscopy image, of the first sample and the second sparse set of S sub-images, including the first sub-image of size [a×b] pixels wherein a,b∈[2, min{M,N}], of the first sample are simultaneously (i.e. concurrently, in parallel, at the same time) obtained and acquired, respectively.

In one example, obtaining, using the first detector, the first set of electron microscopy images, including the first electron microscopy image, of the first sample; and acquiring, using the second detector, the second sparse set of S sub-images, including the first sub-image of size [a×b] pixels wherein a,b∈[2,min{M,N}], of the first sample; comprises simultaneously obtaining, using the first detector, the first electron microscopy image, included in the first set of electron microscopy images, of the first sample; and acquiring, using the second detector, the second sparse set of S sub-images, including the first sub-image of size [a×b] pixels wherein a,b∈[2,min{M,N}], of the first sample.

In this way, the first electron microscopy image, included in the first set of electron microscopy images, the first sample and the second sparse set of S sub-images, including the first sub-image of size [a×b] pixels wherein a,b∈[2, min{M,N}], of the first sample are simultaneously (i.e. concurrently, in parallel, at the same time) obtained and acquired, respectively.

In one example, obtaining, using the first detector, the first set of electron microscopy images, including the first electron microscopy image, of the first sample; and acquiring, using the second detector, the second sparse set of S sub-images, including the first sub-image of size [a×b] pixels wherein a,b∈[2, min{M,N}], of the first sample; comprises successively obtaining, using the first detector, the first set of electron microscopy images, including the first electron microscopy image, of the first sample; and acquiring, using the second detector, the second sparse set of S sub-images, including the first sub-image of size [a×b] pixels wherein a,b∈[2,min{M,N}], of the first sample.

In this way, the first set of electron microscopy images, including the first electron microscopy image, of the first sample and the second sparse set of S sub-images, including the first sub-image of size [a×b] pixels wherein a,b∈[2,min{M,N}], of the first sample are successively (i.e. consecutively, in series, at different times) obtained and acquired, respectively.

In one example, obtaining, using the first detector, the first set of electron microscopy images, including the first electron microscopy image, of the first sample; and acquiring, using the second detector, the second sparse set of S sub-images, including the first sub-image of size [a×b] pixels wherein a,b∈[2, min{M,N}], of the first sample; comprises successively obtaining, using the first detector, the first electron microscopy image, included in the first set of electron microscopy images, of the first sample; and acquiring, using the second detector, the second sparse set of S sub-images, including the first sub-image of size [a×b] pixels wherein a,b∈[2,min{M,N}], of the first sample.

In this way, the first electron microscopy image, included in the first set of electron microscopy images, the first sample and the second sparse set of S sub-images, including the first sub-image of size [a×b] pixels wherein a,b∈[2,min{M,N}], of the first sample are successively (i.e. consecutively, in series, at different times) obtained and acquired, respectively.

### Reconstructing

The method comprises reconstructing the second set of electron microscopy images, including the first electron microscopy image of size [M×N] pixels, of the first sample using the acquired second sparse set of S sub-images of the first sample and the learned set of dictionaries. Reconstructing images using sparse sets of S sub-images (also known as sub-sampled images) and dictionaries is known, for example as described in the Background of the invention, which is not repeated, for brevity.

In one example, reconstructing the second set of electron microscopy images, including the first electron microscopy image of size [M×N] pixels, of the first sample using the acquired second sparse set of S sub-images of the first sample and the learned set of dictionaries comprises and/or is reconstructing the second set of electron microscopy images, including the first electron microscopy image of size [M×N] pixels, of the first sample using the acquired second sparse set of S sub-images of the first sample and the learned set of dictionaries, wherein the second electron microscopy image of size [M×N] pixels of the first sample is selected from a group consisting of: a backscattered electron image; a visible light image; a Auger electron image; a characteristic or Bremsstrahlung X-ray image; an energy dispersive spectroscopy, EDS, image; an energy dispersive X-ray spectroscopy, EDX, image; a secondary electron image; an electron energy loss spectroscopy, EELS, image; and a contrast image for example a dark field image such as a high-angle annular dark-field image or a annular dark field image; a bright field image such as a annular bright field image; or a Z contrast image; preferably wherein the second electron microscopy image of size [M×N] pixels of the first sample is selected from a group consisting of: a characteristic or Bremsstrahlung X-ray image; an energy dispersive spectroscopy, EDS, image; an energy dispersive X-ray spectroscopy, EDX, image; a secondary electron image; an electron energy loss spectroscopy, EELS, image; and a sparse contrast image for example a sparse dark field image such as a sparse high-angle annular dark-field image or a sparse annular dark field image.

In this way, a multi-band or hyperspectral image (such as a characteristic or Bremsstrahlung X-ray image, an energy dispersive spectroscopy, EDS, image, an energy dispersive X-ray spectroscopy, EDX, image, a secondary electron image, an electron energy loss spectroscopy, EELS, image) and/or a contrast image (for example a dark field image such as a high-angle annular dark-field image or a annular dark field image) is reconstructed from the sub-sampled image of the first image, acquired using the second detector, using the learned set of dictionaries, which are learned using the first set of electron microscopy images, including the first electron microscopy image, of the first sample, obtained using the first detector, for example having a relatively higher quality, resolution, sensitivity and/or signal to noise ratio than the second detector, for example a high-angle annular dark-field image or an annular dark field image; a bright field image such as an annular bright field image; or a Z contrast image.

In one example, reconstructing the second set of electron microscopy images, including the first electron microscopy image of size [M×N] pixels, of the first sample using the acquired second sparse set of S sub-images of the first sample and the learned set of dictionaries comprises reconstructing the second set of electron microscopy images, including the first electron microscopy image of size [M×N] pixels, of the first sample using the acquired second sparse set of S sub-images of the first sample and the learned set of dictionaries according to a target property and/or a respective threshold thereof.

In one example, the target property is a Structural Similarity Index (SSIM) and the respective threshold thereof is at least 60%, preferably at least 70%, more preferably at least 80%, most preferably at least 90%. Generally, the SSIM is a perceptual metric that quantifies the perceptual difference between two similar images, for example image quality degradation caused by processing such as data compression or by losses in data transmission. As applied to the method according to the first aspect, the perceptual difference results from approximation of the reconstruction, according to the obtained respective thresholds of the one or more target properties of the reconstructed electron microscopy image. The SSIM is a full reference metric that requires two images from the same image capture: a reference image and a processed image. As applied to the method according to the first aspect, the reference image is thus an ideal or quasi-ideal reconstructed electron microscopy image, computed according to the target properties of the reconstructed electron microscopy image (i.e. exact, without permissible thresholds) or an acquired electron microscopy image while the processed image is the reconstructed electron microscopy image computed according to the obtained respective thresholds of the one or more target properties of the reconstructed electron reconstructed image. It should be understood that a reference image is not provided for each reconstructed electron microscopy image; rather, reference images are provided for representative reconstructed electron microscopy images and the computing thereof to achieve the respective thresholds of the one or more target properties applied to computing of other reconstructed electron microscopy images. In other words, the required computing so as to achieve the respective thresholds of the one or more target properties is learned.

In one example, the target property is a Peak Signal-to-Noise Ratio (PSNR) and the respective threshold thereof is at least 60%, preferably at least 70%, more preferably at least 80%, most preferably at least 90%. PSNR estimates absolute error. PSNR is usually expressed as a logarithmic quantity using the decibel scale. PSNR is commonly used to measure the quality of reconstruction of lossy compression codecs (e.g., for image compression).

In one example, the target property is a mean squared error (MSE) and the respective threshold thereof is at least 60%, preferably at least 70%, more preferably at least 80%, most preferably at least 90%. MSE estimates absolute error. As MSE is derived from the square of Euclidean distance, the MSE is always a positive value with the error decreasing as the error approaches zero. MSE may be used either to assess a quality of a predictor (i.e. a function mapping arbitrary inputs to a sample of values of some random variable), or of an estimator (i.e. a mathematical function mapping a sample of data to an estimate of a parameter of the population from which the data is sampled).

PSNR and MSE both estimate absolute errors. In contrast, SSIM accounts for the strong interdependencies between pixels, especially closely-spaced pixels. These inter-dependencies carry important information about the structure of the objects in the image. For example, luminance masking is a phenomenon whereby image distortions tend to be less visible in bright regions, while contrast masking is a phenomenon whereby distortions become less visible where there is significant activity or “texture” in the image. Hence, SSIM is preferred.

Resolution and sensitivity/contrast were previously standard STEM image quality metrics but are subjective, being dependent on where measured. Hence, PSNR, MSE and SSIM are preferred. Other quality metrics, including those not requiring a reference, are under development and may be applied mutatis mutandis.

In one example, the method comprises selecting a subset of p₁′ atoms from the set of p₁ atoms included in the first dictionary, included in the learned set of dictionaries; and wherein reconstructing the second set of electron microscopy images, including the first electron microscopy image of size [M×N] pixels, of the first sample using the acquired second sparse set of S sub-images of the first sample and the learned set of dictionaries comprises reconstructing the second set of electron microscopy images, including the first electron microscopy image of size [M×N] pixels, of the first sample using, for example only using, the acquired second sparse set of S sub-images of the first sample and the selected subset of p₁′ atoms included in the first dictionary, included in the learned set of dictionaries.

In this way, the method according to the first aspect provides a method of adaptive dictionary element selection, in which undesired atoms are pruned (i.e. removed) from the first dictionary, included in the learned set of dictionaries, thereby increasing an efficiency of reconstructing the electron microscopy image of the first sample while not adversely affecting a quality thereof.

In one example, selecting the subset of

$${p}_{1}^{′}$$

atoms from the set of p₁ atoms included in the first pre-learned dictionary comprises selecting the subset of

$${p}_{1}^{′}$$

atoms from the set of p₁ atoms included in the first dictionary based on residual energies of the respective atoms of the set of p₁ atoms, for example wherein respective atoms of the subset of

$${p}_{1}^{′}$$

atoms have respective energies of at most or of at least a threshold residual energy.

In this way, the subset of

$${p}_{1}^{′}$$

atoms are selected from the set of p₁ atoms based on the residual energies of the respective atoms of the set of p₁ atoms, for example to reduce and/or minimise affecting a quality of the reconstructed image.

### Inpainting

In one example, reconstructing the second set of electron microscopy images, including the first electron microscopy image of size [M×N] pixels, of the first sample using the acquired second sparse set of S sub-images of the first sample and the learned set of dictionaries comprises inpainting. For example, an inpainting algorithm may be used to fill in gaps in the sub-sampled data, with missing information inferred from the sub-sampled data through a combination of a dictionary learning algorithm and a sparsity pursuit algorithm. A common class of inpainting algorithms involve sparse dictionary learning. Dictionary learning algorithms produce a dictionary of basic signal patterns, which is learned from the data, which is able to via a sparse linear combination with a set of corresponding weights. This dictionary is then used in conjunction with a sparse pursuit algorithm to inpaint the pixels of each overlapping patch which when combined form a full image.

### Machine Learning

In one example, the method comprises training a machine learning, ML, algorithm comprising determining relationships between the respective electron microscopy images of the first set of electron microscopy images and the respective learned dictionaries of the learned set of dictionaries.

In one example, training the ML algorithm comprises providing a master learned dictionary using the determined relationships.

In one example, providing the master learned dictionary using the determined relationships comprises updating, for example iteratively, the master learned dictionary, for example comprising determining relationships between respective electron microscopy images of a first set of electron microscopy images, including a first electron microscopy image, obtained for a second sample, and respective learned dictionaries of a learned set of dictionaries, dictionary learned using the obtained first set of electron microscopy images of the second sample.

In one example, reconstructing the second set of electron microscopy images, including the first electron microscopy image of size [M×N] pixels, of the first sample using the acquired second sparse set of S sub-images of the first sample and the learned set of dictionaries comprises reconstructing the second set of electron microscopy images, including the first electron microscopy image of size [M×N] pixels, of the first sample using the acquired second sparse set of S sub-images of the first sample and the trained ML algorithm and/or the master learned dictionary.

### Transformations

In one example, the method comprises transforming the first electron microscopy image included in the first set of electron microscopy images, the first sub-image of size [a×b] pixels included in the second sparse set of S sub-images and/or one or more atoms of the set of p₁ atoms included in the first dictionary. In one example, transforming comprises and/or is rotating, resizing, translating and/or applying a transformation matrix to the first electron microscopy image included in the first set of electron microscopy images, the first sub-image of size [a×b] pixels included in the second sparse set of S sub-images and/or one or more atoms of the set of p₁ atoms included in the first dictionary.

### Controlling an Electron Microscope

The second aspect provides a method of controlling an electron microscope, the method implemented, at least in part, by a computer comprising a processor and a memory, the method comprising:
obtaining parameters of the electron microscopy;
acquiring, using a first detector, a first set of electron microscopy images, including a first electron microscopy image, of the first sample comprising controlling the electron microscope using the obtained parameters of the electron microscopy;
acquiring, using a second detector, a second sparse set of S sub-images, including a first sub-image of size [a×b] pixels wherein a,b∈[2,min{M,N}], of the first sample comprising controlling the electron microscope using the obtained parameters of the electron microscopy; reconstructing a second set of electron microscopy images, including a first electron microscopy image of size [M×N] pixels, of the first sample according to any of claims 1 to 10 using the acquired second sparse set of S sub-images;
comparing the first electron microscopy image, included in the second set of electron microscopy images, against thresholds of one or more target properties of the first electron microscopy image, included in the second set of electron microscopy images;
adapting the parameters of the electron microscopy based on a result of the comparing; and
acquiring an adapted second sparse set of S acquired sub-images, including a first sub-image of size [a×b] pixels wherein a,b∈[2, min{M,N}], of the first sample comprising controlling the electron microscope using the adapted parameters of the electron microscopy.

In this way, the reconstructed second set of electron microscopy images of the first sample is used to adapt, for example optimise, the parameters of the electron microscopy in silico before subsequently acquiring further images of the first sample using the electron microscope. In this way, a duty cycle of the electron microscope and/or a quality of the acquired image may be enhanced while damage to the sample reduced.

The method comprises comparing the first electron microscopy image, included in the second set of electron microscopy images, against thresholds of one or more target properties of the first electron microscopy image, included in the second set of electron microscopy images, for example for validation thereof. Validation mitigates aberrations and/or artefacts due to the electron microscopy, for example due to incorrect parameters of the electron microscopy, operational errors and/or peculiarities of the sample. Optionally, based on a result of the comparing, the parameters of the electron microscope are adapted and another image of the sample is acquired, using the adapted parameters. That is, the parameters of the electron microscope are optimised or refined for the sample. In this way a quality of the second acquired image may be further enhanced while damage to the sample controlled.

In one example, adapting the parameters of the electron microscopy based on a result of the comparing comprises:
adapting, for example iteratively, recursively and/or repeatedly, the parameters of the electron microscopy, attributes of the sample and/or respective thresholds of the one or more target properties of the first electron microscopy image, included in the second set of electron microscopy images; and
reconstructing the second set of electron microscopy images, including a first electron microscopy image of size [M×N] pixels, of the first sample using the updated parameters of the electron microscopy and/or the adapted attributes of the first sample, according to the updated respective thresholds of the one or more target properties of the simulated electron microscopy image.

In this way, the second set of electron microscopy images is optimised since the parameters of the electron microscopy, the attributes of the sample and/or the respective thresholds of the one or more target properties of the electron microscopy image are updated, for example iteratively, recursively and/or repeatedly, so as to improve the quality of the second set of electron microscopy images, within the respective thresholds of the one or more target properties and/or within a computer resource budget, as described previously.

It should be understood that the acquired image of the sample is a measured image, for example acquired using a detector of the electron microscope.

In one example, the method comprises:
reconstructing a second electron microscopy image, included in the second set of electron microscopy images, of size [M×N] pixels of the first sample according to the first aspect using the acquired adapted second sparse set of S sub-images.

### Parameters of Electron Microscopy

The method comprises obtaining parameters (also known as settings or acquisition parameters) of the electron microscopy. In this way, the simulated electron microscopy image is computed to correspond with an acquired electron microscopy image of the sample. In one example, the parameters include: accelerating voltage, circle aberration coefficient Cs (which determines beam size), ADF detector or equivalent. Other parameters are known. In one example, the parameters additionally and/or alternatively include: condenser lens parameter (for example source spread function, defocus spread function and/or zero defocus reference) and/or objective lens parameters (for example source spread function, defocus spread function and/or zero defocus reference). It should be understood that particular electron microscopes implement particular parameters, subsets and/or combinations thereof.

### Attributes of Sample

Generally, the attributes are and/or represent physical and/or chemical characteristics of the sample. In one example, the attributes include chemical composition, structure, crystallography, lattice parameters, thickness, orientation with respect to electron beam and/or microstructure. Other attributes are known. For example, examples of other attributes include, but are not limited to, regional intensity maxima, edges, periodicity, regional chemical composition, or combinations thereof. For example, intensity maxima in the image data may represent peaks associated with particles, molecules, and/or atoms. Edges in the image data may represent particle boundaries, grain boundaries, crystalline dislocations, stress/strain boundaries, interfaces between different compositions/crystalline structures, and combinations thereof. Periodicity in the image data may be related to crystallinity and/or patterned objects. Computational analysis may be performed on the image data including, but are not limited to, a theoretically optimal sparsifying transform technique, an edge detection technique, a Gaussian mixture regression technique, a summary statistics technique, a measures of spatial variability technique, an entropy technique, a matrix decomposition information technique, a peak finding technique, or a combination thereof. Typically, the sample has a thickness of 1 to 20 unit cells. Generally, a patch is at least 2×2 pixels. In one example, the sample is crystalline. In one example, the sample is non-crystalline e.g. amorphous. Non-crystalline samples may be simulated mutatis mutandis.

### Computer, Computer Program, Non-Transient Computer-Readable Storage Medium

The third aspect provides a computer comprising a processor and a memory configured to implement a method according to any of the first aspect and/or the second aspect, a computer program comprising instructions which, when executed by a computer comprising a processor and a memory, cause the computer to perform a method according to any of the first aspect and/or the second aspect or a non-transient computer-readable storage medium comprising instructions which, when executed by a computer comprising a processor and a memory, cause the computer to perform a method according to any of the first aspect and/or the second aspect.

### Electron Microscope

The fourth aspect provides an electron microscope including a computer comprising a processor and a memory configured to implement a method according to any of the first aspect and/or the second aspect.

### Use

The fifth aspect provides use of a dictionary, learned using a first electron microscopy image, obtained using a first detector, of a sample, in reconstructing a second electron microscopy image, acquired using a second detector, of the sample.

### DEFINITIONS

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a Scanning Transmission Electron Microscope (STEM), comprising an electron gun, condenser lenses, deflection scan coils, lens, detectors (HAADF, ADF, ABF), amplification/processing and HAADF, ADF, and ABF images, detected using the corresponding detectors, of a sample (~0.1 nm thin);

FIG. 2 schematically depicts the STEM of FIG. 1 in more detail, further showing additional signals from backscattered electrons (BSE) for EBSD, visible light (cathodoluminescence), Auger electrons, characteristic/Bremsstrahlung X-rays (for EDS and EDX), secondary electrons, incoherently scattered beam electrons and inelastically scattered beam electrons (for EELS), detected using corresponding detectors;

FIG. 3A shows energy-dispersive X-ray spectroscopy maps overlayed on a backscattered electron image; and FIGS. 3B and 3C show acquired spectra;

FIG. 4A shows an energy-dispersive X-ray spectrum for a 100 μs acquisition time; FIG. 4B shows respective Z-contrast energy-dispersive X-ray spectroscopy maps (images) for the 100 μs acquisition time for the energy-dispersive X-ray spectrum of FIG. 4A; FIG. 4C shows an energy-dispersive X-ray spectrum for a 1 μs acquisition time; and FIG. 4D shows respective Z-contrast energy-dispersive X-ray spectroscopy maps (images) for the 1 μs acquisition time for the energy-dispersive X-ray spectrum of FIG. 4C;

FIG. 5A shows example 2-Dimensional Dictionaries (a) a DCT Dictionary; (b) a separable HAAR Dictionary; (c) an example of a learned dictionary, fitted to reconstruct the ‘Barbara’ image shown in (d) a publicly available image used for testing. Dictionaries (a) and (b) were generated using the ‘sparselandtools’ Python module; FIG. 5B shows (a) a 512×512 fully sampled atomic resolution Z-contrast image of Ceria; (b) 6.25% sub-sampled line-hop image acquired with the same conditions at the same location; and (c) reconstruction of the 6.25% sub-sampled image using BPFA; FIG. 5C shows a fully sampled image of a sample; FIG. 5D shows a 20% sub-sampled image of the sample of FIG. 5C; FIG. 5E shows the learned dictionary, learned using the fully sampled image of FIG. 5C; and FIG. 5F shows a reconstructed image of the sample of FIG. 5C, reconstructed using the 20% sub-sampled image of FIG. 5D and the learned dictionary of FIG. 5E;

FIG. 6A schematically depicts a method of dictionary learning of a dictionary (right) using the ‘Barbara’ image (left) and matching pursuit; FIG. 6B shows a visualisation of the matching pursuit; and FIG. 6C shows (a) a 512×512 fully sampled atomic resolution Z-contrast image of Ceria; (b) 6.25% sub-sampled line-hop image acquired with the same conditions at the same location; and (c) reconstruction of the 6.25% sub-sampled image using BPFA;

FIG. 7A shows a BSE image of a sample; FIG. 7B shows respective Z-contrast energy-dispersive X-ray spectroscopy (EDS) maps (images) for the sample of FIG. 7A for a 100 μs acquisition time; FIG. 7C shows respective Z-contrast energy-dispersive X-ray spectroscopy (EDS) maps (images) for the sample of FIG. 7A for a 1 μs acquisition time; and FIG. 7D schematically depicts a method according to an exemplary embodiment, comprising training a dictionary for each band and reconstructing each band independently using the corresponding dictionary;

FIG. 8A shows respective Z-contrast energy-dispersive X-ray spectroscopy (EDS) maps (images) of a sample for a 100 μs acquisition time; FIG. 8B shows respective sub-sampled Z-contrast EDS maps (images) for the sample of FIG. 8A for a 75% sub-sampling; FIG. 8C shows respective reconstructed Z-contrast EDS maps (images) for the sample of FIG. 8A, reconstructed using the respective sub-sampled Z-contrast EDS maps (images) of FIG. 8B and a learned dictionary, learned using the EDS image of FIG. 8A; FIG. 8D shows respective Z-contrast energy-dispersive X-ray spectroscopy (EDS) maps (images) of the sample of FIG. 8A for a 100 μs acquisition time; FIG. 8E shows respective sub-sampled Z-contrast EDS maps (images) for the sample of FIG. 8A for a 50% sub-sampling; and FIG. 8F shows respective reconstructed Z-contrast EDS maps (images) for the sample of FIG. 8D, reconstructed using the respective sub-sampled Z-contrast EDS maps (images) of FIG. 8E and a learned dictionary, learned using the EDS image of FIG. 8D;

FIG. 9A shows respective Z-contrast energy-dispersive X-ray spectroscopy (EDS) maps (images) of the sample of FIG. 8A for a 100 μs acquisition time; FIG. 9B shows respective sub-sampled Z-contrast EDS maps (images) for the sample of FIG. 9A for a 25% sub-sampling; FIG. 9C shows respective reconstructed Z-contrast EDS maps (images) for the sample of FIG. 9A, reconstructed using the respective sub-sampled Z-contrast EDS maps (images) of FIG. 9B and a learned dictionary, learned using the EDS image of FIG. 9A; FIG. 9D shows respective Z-contrast energy-dispersive X-ray spectroscopy (EDS) maps (images) of the sample of FIG. 8A for a 100 μs acquisition time; FIG. 9E shows respective sub-sampled Z-contrast EDS maps (images) for the sample of FIG. 9A for a 12.5% sub-sampling; and FIG. 9F shows respective reconstructed Z-contrast EDS maps (images) for the sample of FIG. 9D, reconstructed using the respective sub-sampled Z-contrast EDS maps (images) of FIG. 9E and a learned dictionary, learned using the EDS image of FIG. 9D;

FIG. 10A shows respective Z-contrast energy-dispersive X-ray spectroscopy (EDS) maps (images) of the sample of FIG. 8A for a 100 μs acquisition time; FIG. 10B shows respective sub-sampled Z-contrast EDS maps (images) for the sample of FIG. 10A for a 6.25% sub-sampling; FIG. 10C shows respective reconstructed Z-contrast EDS maps (images) for the sample of FIG. 10A, reconstructed using the respective sub-sampled Z-contrast EDS maps (images) of FIG. 10B and a learned dictionary, learned using the EDS image of FIG. 10A; FIG. 10D shows respective Z-contrast energy-dispersive X-ray spectroscopy (EDS) maps (images) of the sample of FIG. 8A for a 100 μs acquisition time; FIG. 10E shows respective sub-sampled Z-contrast EDS maps (images) for the sample of FIG. 10A for a 3.125% sub-sampling; and FIG. 10F shows respective reconstructed Z-contrast EDS maps (images) for the sample of FIG. 10D, reconstructed using the respective sub-sampled Z-contrast EDS maps (images) of FIG. 10E and a learned dictionary, learned using the EDS image of FIG. 10D;

FIG. 11A shows a BSE image of a sample; FIG. 11B shows a dictionary learned using the BSE image of FIG. 11A; FIG. 11C shows respective Z-contrast energy-dispersive X-ray spectroscopy (EDS) maps (images) of the sample of FIG. 11A for a 100 μs acquisition time; and FIG. 11D shows respective Z-contrast energy-dispersive X-ray spectroscopy (EDS) maps (images) of the sample of FIG. 11A for a 1 μs acquisition time;

FIG. 12A shows respective Z-contrast energy-dispersive X-ray spectroscopy (EDS) maps (images) of the sample of FIG. 8A for a 100 μs acquisition time; FIG. 12B shows respective reconstructed Z-contrast EDS maps (images) for the sample of FIG. 12A, reconstructed using the respective sub-sampled Z-contrast EDS maps (images) of FIG. 9E for a 12.5% subsampling and a learned dictionary, learned using the EDS image of FIG. 12A (same as FIG. 11C); FIG. 12C shows respective reconstructed Z-contrast EDS maps (images) for the sample of FIG. 12A, reconstructed using the respective sub-sampled Z-contrast EDS maps (images) of FIG. 9E for a 12.5% subsampling and a learned dictionary (FIG. 11B), learned using the BSE image of FIG. 11A, according to an exemplary embodiment, in which reconstruction is improved (improved quality, resolution, sensitivity and/or signal to noise ratio) compared with FIG. 12B; FIG. 12D shows respective Z-contrast energy-dispersive X-ray spectroscopy (EDS) maps (images) of the sample of FIG. 8A for a 100 μs acquisition time; FIG. 12E shows respective reconstructed Z-contrast EDS maps (images) for the sample of FIG. 12D, reconstructed using the respective sub-sampled Z-contrast EDS maps (images) of FIG. 10B for a 6.25% subsampling and a learned dictionary, learned using the EDS image of FIG. 12A; and FIG. 12F shows respective reconstructed Z-contrast EDS maps (images) for the sample of FIG. 12D, reconstructed using the respective sub-sampled Z-contrast EDS maps (images) of FIG. 10B for a 6.25% subsampling and a learned dictionary (FIG. 11B), learned using the BSE image of FIG. 11A, according to an exemplary embodiment, in which reconstruction is improved (improved quality, resolution, sensitivity and/or signal to noise ratio) compared with FIG. 12D; and

FIG. 13A shows respective Z-contrast energy-dispersive X-ray spectroscopy (EDS) maps (images) of the sample of FIG. 8A for a 100 μs acquisition time; FIG. 13B shows respective reconstructed Z-contrast EDS maps (images) for the sample of FIG. 13A, reconstructed using the respective sub-sampled Z-contrast EDS maps (images) of FIG. 10E for a 3.125% subsampling and a learned dictionary, learned using the EDS image of FIG. 13A (same as FIG. 11C); FIG. 13C shows respective reconstructed Z-contrast EDS maps (images) for the sample of FIG. 13A, reconstructed using the respective sub-sampled Z-contrast EDS maps (images) of FIG. 9E for a 3.125% subsampling and a learned dictionary (FIG. 11B), learned using the BSE image of FIG. 11A, according to an exemplary embodiment, in which reconstruction is improved (improved quality, resolution, sensitivity and/or signal to noise ratio) compared with FIG. 13B; FIG. 13D shows respective Z-contrast energy-dispersive X-ray spectroscopy (EDS) maps (images) of the sample of FIG. 8A for a 100 μs acquisition time; FIG. 13E shows respective reconstructed Z-contrast EDS maps (images) for the sample of FIG. 13D, reconstructed using the respective sub-sampled Z-contrast EDS maps (images) of FIG. 10B for a 1.562% subsampling and a learned dictionary, learned using a 1.562% sub-sampled EDS image; and FIG. 13F shows respective reconstructed Z-contrast EDS maps (images) for the sample of FIG. 13D, reconstructed using the respective sub-sampled Z-contrast EDS maps (images) for a 1.562% subsampling and a learned dictionary (FIG. 11B), learned using the BSE image of FIG. 11A, according to an exemplary embodiment, in which reconstruction is improved (improved quality, resolution, sensitivity and/or signal to noise ratio) compared with FIG. 13D.

### DETAILED DESCRIPTION OF THE DRAWINGS

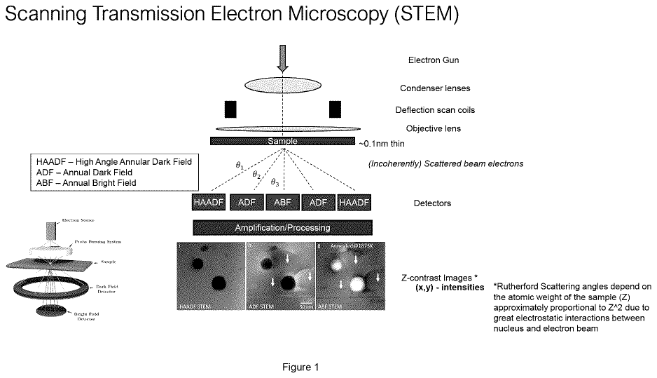

FIG. 1 schematically depicts a Scanning Transmission Electron Microscope (STEM), comprising an electron gun, condenser lenses, deflection scan coils, lens, detectors (HAADF, ADF, ABF), amplification/processing and HAADF, ADF, and ABF images, detected using the corresponding detectors, of a sample (~0.1 nm thin).

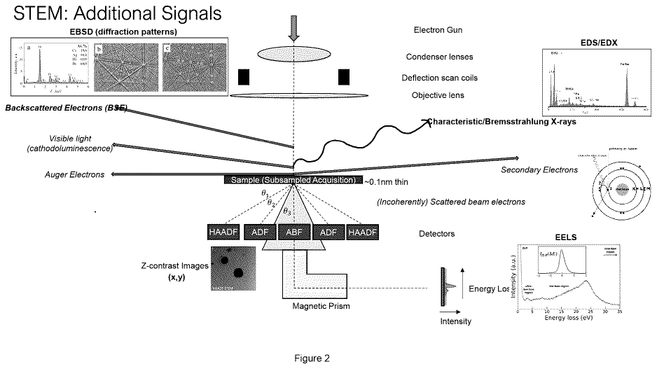

FIG. 2 schematically depicts the STEM of FIG. 1 in more detail, further showing additional signals from backscattered electrons (BSE) for EBSD, visible light (cathodoluminescence), Auger electrons, characteristic/Bremsstrahlung X-rays (for EDS and EDX), secondary electrons, incoherently scattered beam electrons and inelastically scattered beam electrons (for EELS), detected using corresponding detectors.

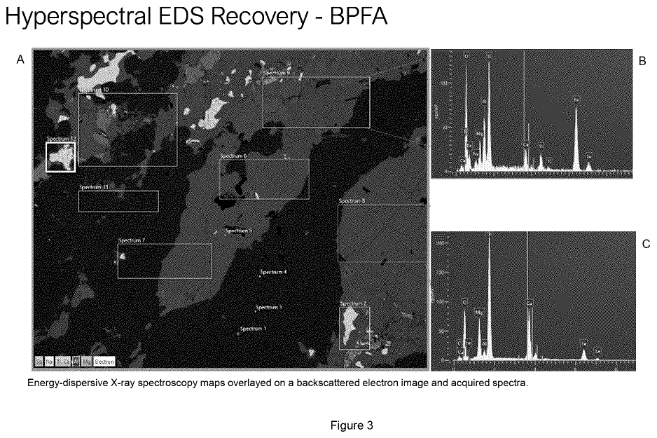

FIG. 3A shows energy-dispersive X-ray spectroscopy maps overlayed on a backscattered electron image; and FIGS. 3B and 3C show acquired spectra.

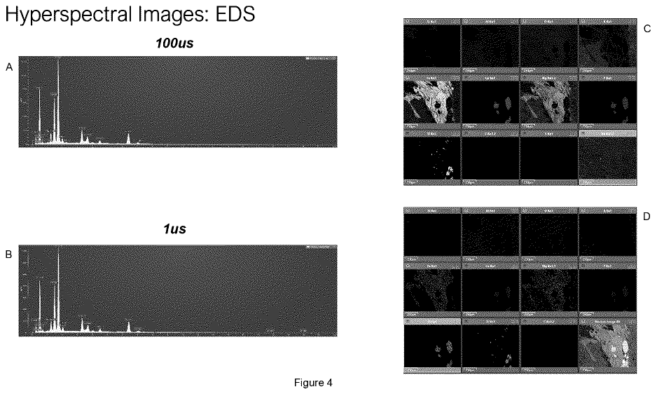

FIG. 4A shows an energy-dispersive X-ray spectrum for a 100 μs acquisition time; FIG. 4B shows respective Z-contrast energy-dispersive X-ray spectroscopy maps (images) for the 100 μs acquisition time for the energy-dispersive X-ray spectrum of FIG. 4A; FIG. 4C shows an energy-dispersive X-ray spectrum for a 1 μs acquisition time; and FIG. 4D shows respective Z-contrast energy-dispersive X-ray spectroscopy maps (images) for the 1 μs acquisition time for the energy-dispersive X-ray spectrum of FIG. 4C.

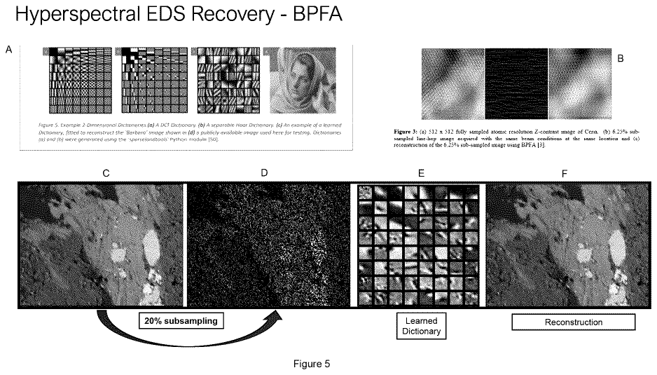

FIG. 5A shows example 2-Dimensional Dictionaries (a) a DCT Dictionary; (b) a separable HAAR Dictionary; (c) an example of a learned dictionary, fitted to reconstruct the ‘Barbara’ image shown in (d) a publicly available image used for testing. Dictionaries (a) and (b) were generated using the ‘sparselandtools’ Python module; FIG. 5B shows (a) a 512×512 fully sampled atomic resolution Z-contrast image of Ceria; (b) 6.25% sub-sampled line-hop image acquired with the same conditions at the same location; and (c) reconstruction of the 6.25% sub-sampled image using BPFA; FIG. 5C shows a fully sampled image of a sample; FIG. 5D shows a 20% sub-sampled image of the sample of FIG. 5C; FIG. 5E shows the learned dictionary, learned using the fully sampled image of FIG. 5C; and FIG. 5F shows a reconstructed image of the sample of FIG. 5C, reconstructed using the 20% sub-sampled image of FIG. 5D and the learned dictionary of FIG. 5E.

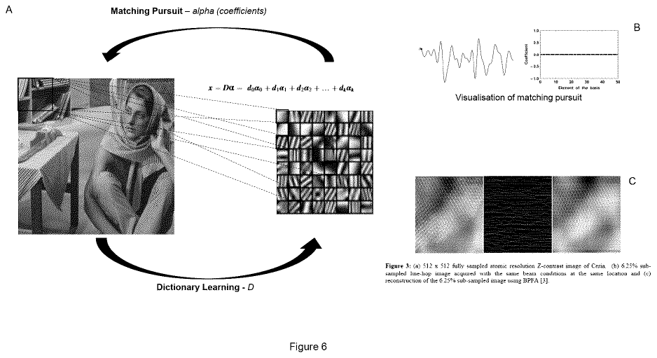

FIG. 6A schematically depicts a method of dictionary learning of a dictionary (right) using the ‘Barbara’ image (left) and matching pursuit; FIG. 6B shows a visualisation of the matching pursuit; and FIG. 6C shows (a) a 512×512 fully sampled atomic resolution Z-contrast image of Ceria; (b) 6.25% sub-sampled line-hop image acquired with the same conditions at the same location; and (c) reconstruction of the 6.25% sub-sampled image using BPFA;

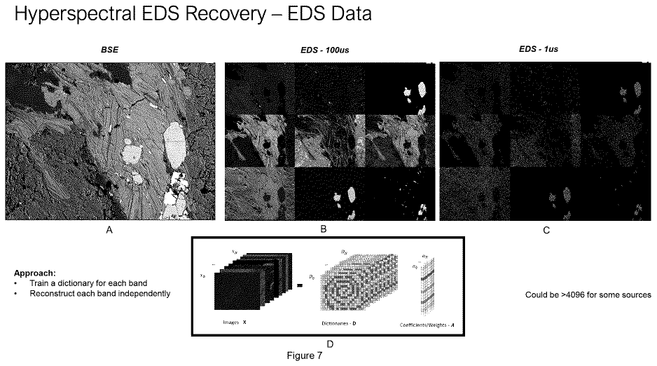

FIG. 7A shows a BSE image of a sample; FIG. 7B shows respective Z-contrast energy-dispersive X-ray spectroscopy (EDS) maps (images) for the sample of FIG. 7A for a 100 μs acquisition time; FIG. 7C shows respective Z-contrast energy-dispersive X-ray spectroscopy (EDS) maps (images) for the sample of FIG. 7A for a 1 μs acquisition time; and FIG. 7D schematically depicts a method according to an exemplary embodiment, comprising training a dictionary for each band and reconstructing each band independently using the corresponding dictionary.

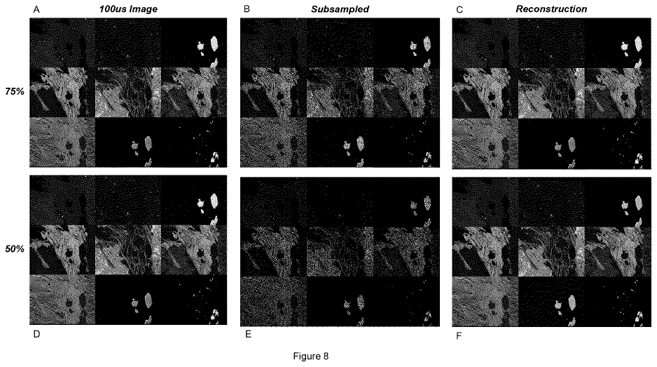

FIG. 8A shows respective Z-contrast energy-dispersive X-ray spectroscopy (EDS) maps (images) of a sample for a 100 μs acquisition time; FIG. 8B shows respective sub-sampled Z-contrast EDS maps (images) for the sample of FIG. 8A for a 75% sub-sampling; FIG. 8C shows respective reconstructed Z-contrast EDS maps (images) for the sample of FIG. 8A, reconstructed using the respective sub-sampled Z-contrast EDS maps (images) of FIG. 8B and a learned dictionary, learned using the EDS image of FIG. 8A; FIG. 8D shows respective Z-contrast energy-dispersive X-ray spectroscopy (EDS) maps (images) of the sample of FIG. 8A for a 100 μs acquisition time; FIG. 8E shows respective sub-sampled Z-contrast EDS maps (images) for the sample of FIG. 8A for a 50% sub-sampling; and FIG. 8F shows respective reconstructed Z-contrast EDS maps (images) for the sample of FIG. 8D, reconstructed using the respective sub-sampled Z-contrast EDS maps (images) of FIG. 8E and a learned dictionary, learned using the EDS image of FIG. 8D.

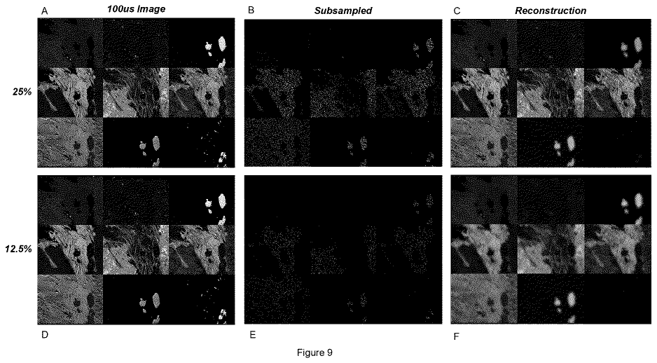

FIG. 9A shows respective Z-contrast energy-dispersive X-ray spectroscopy (EDS) maps (images) of the sample of FIG. 8A for a 100 μs acquisition time; FIG. 9B shows respective sub-sampled Z-contrast EDS maps (images) for the sample of FIG. 9A for a 25% sub-sampling; FIG. 9C shows respective reconstructed Z-contrast EDS maps (images) for the sample of FIG. 9A, reconstructed using the respective sub-sampled Z-contrast EDS maps (images) of FIG. 9B and a learned dictionary, learned using the EDS image of FIG. 9A; FIG. 9D shows respective Z-contrast energy-dispersive X-ray spectroscopy (EDS) maps (images) of the sample of FIG. 8A for a 100 μs acquisition time; FIG. 9E shows respective sub-sampled Z-contrast EDS maps (images) for the sample of FIG. 9A for a 12.5% sub-sampling; and FIG. 9F shows respective reconstructed Z-contrast EDS maps (images) for the sample of FIG. 9D, reconstructed using the respective sub-sampled Z-contrast EDS maps (images) of FIG. 9E and a learned dictionary, learned using the EDS image of FIG. 9D.

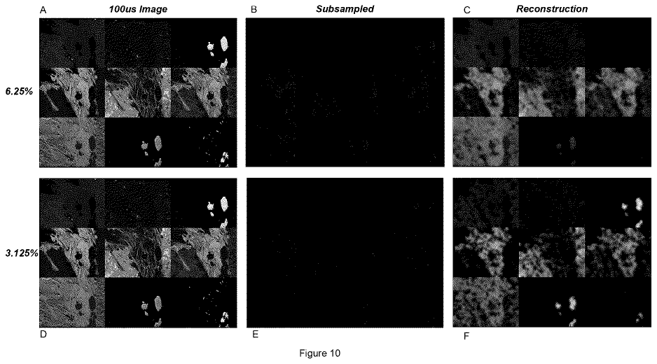

FIG. 10A shows respective Z-contrast energy-dispersive X-ray spectroscopy (EDS) maps (images) of the sample of FIG. 8A for a 100 μs acquisition time; FIG. 10B shows respective sub-sampled Z-contrast EDS maps (images) for the sample of FIG. 10A for a 6.25% sub-sampling; FIG. 10C shows respective reconstructed Z-contrast EDS maps (images) for the sample of FIG. 10A, reconstructed using the respective sub-sampled Z-contrast EDS maps (images) of FIG. 10B and a learned dictionary, learned using the EDS image of FIG. 10A; FIG. 10D shows respective Z-contrast energy-dispersive X-ray spectroscopy (EDS) maps (images) of the sample of FIG. 8A for a 100 μs acquisition time; FIG. 10E shows respective sub-sampled Z-contrast EDS maps (images) for the sample of FIG. 10A for a 3.125% sub-sampling; and FIG. 10F shows respective reconstructed Z-contrast EDS maps (images) for the sample of FIG. 10D, reconstructed using the respective sub-sampled Z-contrast EDS maps (images) of FIG. 10E and a learned dictionary, learned using the EDS image of FIG. 10D.

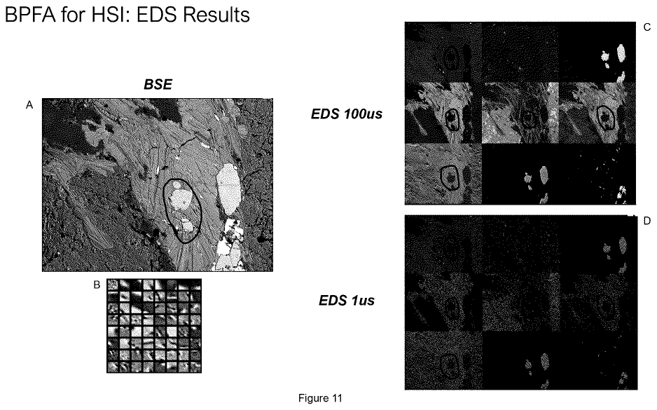

FIG. 11A shows a BSE image of a sample; FIG. 11B shows a dictionary learned using the BSE image of FIG. 11A; FIG. 11C shows respective Z-contrast energy-dispersive X-ray spectroscopy (EDS) maps (images) of the sample of FIG. 11A for a 100 μs acquisition time; and FIG. 11D shows respective Z-contrast energy-dispersive X-ray spectroscopy (EDS) maps (images) of the sample of FIG. 11A for a 1 μs acquisition time.

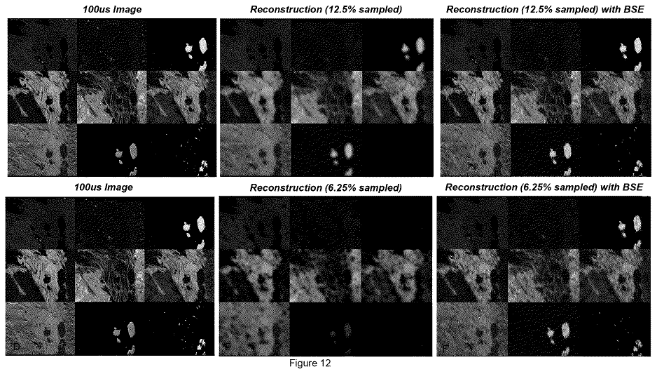

FIG. 12A shows respective Z-contrast energy-dispersive X-ray spectroscopy (EDS) maps (images) of the sample of FIG. 8A for a 100 μs acquisition time; FIG. 12B shows respective reconstructed Z-contrast EDS maps (images) for the sample of FIG. 12A, reconstructed using the respective sub-sampled Z-contrast EDS maps (images) of FIG. 9E for a 12.5% subsampling and a learned dictionary, learned using the EDS image of FIG. 12A (same as FIG. 11C); FIG. 12C shows respective reconstructed Z-contrast EDS maps (images) for the sample of FIG. 12A, reconstructed using the respective sub-sampled Z-contrast EDS maps (images) of FIG. 9E for a 12.5% subsampling and a learned dictionary (FIG. 11B), learned using the BSE image of FIG. 11A, according to an exemplary embodiment, in which reconstruction is improved (improved quality, resolution, sensitivity and/or signal to noise ratio) compared with FIG. 12B; FIG. 12D shows respective Z-contrast energy-dispersive X-ray spectroscopy (EDS) maps (images) of the sample of FIG. 8A for a 100 μs acquisition time; FIG. 12E shows respective reconstructed Z-contrast EDS maps (images) for the sample of FIG. 12D, reconstructed using the respective sub-sampled Z-contrast EDS maps (images) of FIG. 10B for a 6.25% subsampling and a learned dictionary, learned using the EDS image of FIG. 12A; and FIG. 12F shows respective reconstructed Z-contrast EDS maps (images) for the sample of FIG. 12D, reconstructed using the respective sub-sampled Z-contrast EDS maps (images) of FIG. 10B for a 6.25% subsampling and a learned dictionary (FIG. 11B), learned using the BSE image of FIG. 11A, according to an exemplary embodiment, in which reconstruction is improved (improved quality, resolution, sensitivity and/or signal to noise ratio) compared with FIG. 12D; and

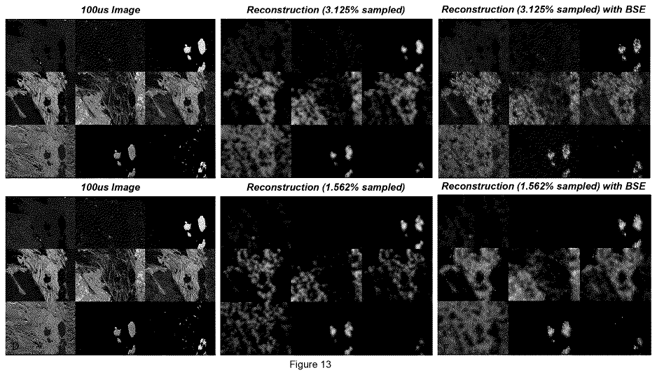

FIG. 13A shows respective Z-contrast energy-dispersive X-ray spectroscopy (EDS) maps (images) of the sample of FIG. 8A for a 100 μs acquisition time; FIG. 13B shows respective reconstructed Z-contrast EDS maps (images) for the sample of FIG. 13A, reconstructed using the respective sub-sampled Z-contrast EDS maps (images) of FIG. 10E for a 3.125% subsampling and a learned dictionary, learned using the EDS image of FIG. 13A (same as FIG. 11C); FIG. 13C shows respective reconstructed Z-contrast EDS maps (images) for the sample of FIG. 13A, reconstructed using the respective sub-sampled Z-contrast EDS maps (images) of FIG. 9E for a 3.125% subsampling and a learned dictionary (FIG. 11B), learned using the BSE image of FIG. 11A, according to an exemplary embodiment, in which reconstruction is improved (improved quality, resolution, sensitivity and/or signal to noise ratio) compared with FIG. 13B; FIG. 13D shows respective Z-contrast energy-dispersive X-ray spectroscopy (EDS) maps (images) of the sample of FIG. 8A for a 100 μs acquisition time; FIG. 13E shows respective reconstructed Z-contrast EDS maps (images) for the sample of FIG. 13D, reconstructed using the respective sub-sampled Z-contrast EDS maps (images) of FIG. 10B for a 1.562% subsampling and a learned dictionary, learned using a 1.562% sub-sampled EDS image; and FIG. 13F shows respective reconstructed Z-contrast EDS maps (images) for the sample of FIG. 13D, reconstructed using the respective sub-sampled Z-contrast EDS maps (images) for a 1.562% subsampling and a learned dictionary (FIG. 11B), learned using the BSE image of FIG. 11A, according to an exemplary embodiment, in which reconstruction is improved (improved quality, resolution, sensitivity and/or signal to noise ratio) compared with FIG. 13D.

FIGS. 12C, 12F, 13C and 13F show that reconstruction of Z-contrast EDS maps using a learned dictionary, learned using a BSE image, according to exemplary embodiments, is improved (improved quality, resolution, sensitivity and/or signal to noise ratio) compared with reconstruction of Z-contrast EDS maps using a learned dictionary (FIGS. 12B, 12E, 13B and 13E, respectively), learned using a Z-contrast EDS map, for sub-sampling of 12.5%, 6.25%, 3.125% and 1.562%, respectively.

Although a preferred embodiment has been shown and described, it will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of reconstructing electron microscopy images of size [M×N] pixels of a first sample, the method implemented by a computer comprising a processor and a memory, the method comprising:
obtaining, using a first detector, a first set of electron microscopy images, including a first electron microscopy image, of the first sample;
dictionary learning a set of dictionaries, including a first dictionary including a set of p₁ atoms, using the obtained first set of electron microscopy images of the first sample;
acquiring, using a second detector, a second sparse set of S sub-images, including a first sub-image of size [a×b] pixels wherein a,b∈[2, min{M,N}], of the first sample; and
reconstructing a second set of electron microscopy images, including a first electron microscopy image of size [M×N] pixels, of the first sample using the acquired second sparse set of S sub-images of the first sample and the learned set of dictionaries.

2. The method according to claim 1, wherein obtaining, using the first detector, the first set of electron microscopy images, including the first electron microscopy image, of the first sample comprises and/or is acquiring, using the first detector, the first set of electron microscopy images, including the first electron microscopy image, of the first sample.

3. The method according to claim 2, wherein acquiring, using the first detector, the first set of electron microscopy images, including the first electron microscopy image, of the first sample comprises:
acquiring, using the first detector, a first sparse set of S sub-images, including a first sub-image of size [a×b] pixels wherein a,b∈[2, min{M,N}], of the first sample; and
reconstructing the first electron microscopy image, included in the first set of electron microscopy images, of the first sample using the acquired first sparse set of S sub-images of the first sample.

4. The method according to claim 2, wherein acquiring, using the first detector, the first set of electron microscopy images, including the first electron microscopy image comprises fully acquiring, using the first detector, the first electron microscopy image, included in the first set of electron microscopy images, wherein the first electron microscopy image, included in the first set of electron microscopy images, of the first sample comprises and/or is a fully sampled acquired electron microscopy image of the first sample.

5. The method according to claim 1,
wherein obtaining, using the first detector, the first set of electron microscopy images, including the first electron microscopy image, of the first sample comprises and/or is obtaining, using the first detector, the first set of electron microscopy images, including the first electron microscopy image, of the first sample,
wherein the first electron microscopy image, included in the first set of electron microscopy images, of the first sample is selected from a group consisting of: a backscattered electron image; a visible light image; an Auger electron image; a characteristic or Bremsstrahlung X-ray image; an energy dispersive spectroscopy, EDS, image; an energy dispersive X-ray spectroscopy, EDX, image; a secondary electron image; an electron energy loss spectroscopy, EELS, image; and a contrast image for example a dark field image such as a high-angle annular dark-field image or an annular dark field image; a bright field image such as an annular bright field image; or a Z contrast image; preferably wherein the first electron microscopy image of the first sample is selected from a group consisting of: a backscattered electron image; and a contrast image for example a dark field image such as a high-angle annular dark-field image or an annular dark field image; a bright field image such as an annular bright field image; or a Z contrast image.

6. The method according to claim 1,
wherein acquiring, using the second detector, the second sparse set of S sub-images, including the first sub-image of size [a×b] pixels wherein a,b∈[2, min{M,N}], of the first sample comprises and/or is acquiring, using the second detector, the second sparse set of S sub-images, including the first sub-image of size [a×b] pixels wherein a,b∈[2, min{M,N}], of the first sample,
wherein the second sparse set of S sub-images, including the first sub-image of size [a×b] pixels wherein a,b∈[2, min{M,N}], of the first sample is selected from a group consisting of: a sparse backscattered electron image; a sparse visible light image; a sparse Auger electron image; a sparse characteristic or Bremsstrahlung X-ray image; a sparse energy dispersive spectroscopy, EDS, image; a sparse energy dispersive X-ray spectroscopy, EDX, image; a sparse secondary electron image; a sparse electron energy loss spectroscopy, EELS, image; and a sparse contrast image for example a sparse dark field image such as a sparse high-angle annular dark-field image or a sparse annular dark field image; a sparse bright field image such as a sparse annular bright field image; or a sparse Z contrast image; preferably wherein the second sparse set of S sub-images, including the first sub-image of size [a×b] pixels wherein a,b∈[2, min{M,N}], of the first sample is selected from a group consisting of: a sparse characteristic or Bremsstrahlung X-ray image; a sparse energy dispersive spectroscopy, EDS, image; a sparse energy dispersive X-ray spectroscopy, EDX, image; a sparse secondary electron image; a sparse electron energy loss spectroscopy, EELS, image; and a sparse contrast image for example a sparse dark field image such as a sparse high-angle annular dark-field image or a sparse annular dark field image.

7. The method according to claim 1,
wherein reconstructing the second set of electron microscopy images, including the first electron microscopy image of size [M×N] pixels, of the first sample using the acquired second sparse set of S sub-images of the first sample and the learned set of dictionaries comprises and/or is reconstructing the second set of electron microscopy images, including the first electron microscopy image of size [M×N] pixels, of the first sample using the acquired second sparse set of S sub-images of the first sample and the learned set of dictionaries,
wherein the second electron microscopy image of size [M×N] pixels of the first sample is selected from a group consisting of: a backscattered electron image; a visible light image; a Auger electron image; a characteristic or Bremsstrahlung X-ray image; a energy dispersive spectroscopy, EDS, image; an energy dispersive X-ray spectroscopy, EDX, image; a secondary electron image; an electron energy loss spectroscopy, EELS, image; and a contrast image for example a dark field image such as a high-angle annular dark-field image or a annular dark field image; a bright field image such as a annular bright field image; or a Z contrast image; preferably wherein the second electron microscopy image of size [M×N] pixels of the first sample is selected from a group consisting of: a characteristic or Bremsstrahlung X-ray image; an energy dispersive spectroscopy, EDS, image; an energy dispersive X-ray spectroscopy, EDX, image; a secondary electron image; an electron energy loss spectroscopy, EELS, image; and a contrast image for example a dark field image such as a high-angle annular dark-field image or an annular dark field image.

8. The method according to claim 1 wherein:
obtaining, using the first detector, the first set of electron microscopy images, including the first electron microscopy image, of the first sample;
acquiring, using the second detector, the second sparse set of S sub-images, including the first sub-image of size [a×b] pixels wherein a,b∈[2, min{M,N}], of the first sample, comprises simultaneously obtaining, using the first detector, the first set of electron microscopy images, including the first electron microscopy image, of the first sample; and
acquiring, using the second detector, the second sparse set of S sub-images, including the first sub-image of size [a×b] pixels wherein a,b∈[2,min{M,N}], of the first sample.

9. The method according to claim 1 wherein:
obtaining, using the first detector, the first set of electron microscopy images, including the first electron microscopy image, of the first sample;
acquiring, using the second detector, the second sparse set of S sub-images, including the first sub-image of size [a×b] pixels wherein a,b∈[2, min{M,N}], of the first sample, comprises successively obtaining, using the first detector, the first set of electron microscopy images, including the first electron microscopy image, of the first sample; and
acquiring, using the second detector, the second sparse set of S sub-images, including the first sub-image of size [a×b] pixels wherein a,b∈[2, min{M,N}], of the first sample.

10. The method according to claim 1, wherein a sensitivity of the first detector is greater than a sensitivity of the second detector.

11. A method of controlling an electron microscope, the method implemented, at least in part, by a computer comprising a processor and a memory, the method comprising:
obtaining parameters of the electron microscopy;
acquiring, using a first detector, a first set of electron microscopy images, including a first electron microscopy image, of the first sample comprising controlling the electron microscope using the obtained parameters of the electron microscopy;
acquiring, using a second detector, a second sparse set of S sub-images, including a first sub-image of size [a×b] pixels wherein a,b∈[2, min{M,N}], of the first sample comprising controlling the electron microscope using the obtained parameters of the electron microscopy;
reconstructing a second set of electron microscopy images, including a first electron microscopy image of size [M×N] pixels, of the first sample according to claim 1 using the acquired second sparse set of S sub-images;
comparing the first electron microscopy image, included in the second set of electron microscopy images, against thresholds of one or more target properties of the first electron microscopy image, included in the second set of electron microscopy images;
adapting the parameters of the electron microscopy based on a result of the comparing; and
acquiring an adapted second sparse set of S acquired sub-images, including a first sub-image of size [a×b] pixels wherein a,b∈[2, min{M,N}], of the first sample comprising controlling the electron microscope using the adapted parameters of the electron microscopy.

12. The method according to claim 11, comprising:
reconstructing a second electron microscopy image, included in the second set of electron microscopy images, of size [M×N] pixels of the first sample using the acquired adapted second sparse set of S sub-images.

13. (canceled)

14. An electron microscope including a computer comprising a processor and a memory configured to implement a method according to claim 1.

15. (canceled)
